(19) United States
(12) Patent Application Publication
(10) Pub. No.: US 2019/0135054 A1
(43) Pub. Date: May 9, 2019

(54) TIRE-PRESSURE MONITORING SYSTEM AND MONITORING DEVICE

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventor: Makoto SABURI, Yokkaichi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 16/096,115

(22) PCT Filed: Apr. 14, 2017
(86) PCT No.: PCT/JP2017/015287

§ 371 Date: Oct. 24, 2018

(30) Foreign Application Priority Data
Apr. 28, 2016 (JP) 2016-091203

(51) Int. Cl. B60C 23/04

(52) U.S. Cl. CPC B60C 23/0416; B60C 23/0447

(57) ABSTRACT

A tire air pressure monitoring system that includes a plurality of sensors; a memory that stores a plurality of tire positions at which the plurality of tires are respectively provided and identifiers of the sensors provided in the tires at the plurality of tire positions in correspondence with each other; and a controller that is configured to: perform wireless communication with the plurality of sensors with use of the identifiers of the sensors and monitors the air pressures of the tires, and transmit to at least one of the tire positions, at different timings, a first request signal that requests a piece of information and includes an identifier of the identifiers that is stored by the memory in correspondence with the at least one tire position, and a second request signal that requests a piece of information regardless of identifier content.

This application is the U.S. National Phase of PCT/JP2017/015287 filed Apr. 14, 2017, which claims priority from JP 2016-091203 filed Apr. 28, 2016, the entire disclosure of which is incorporated herein by reference.

### BACKGROUND

The present disclosure relates to a tire air pressure monitoring system and a monitoring device.

There is a tire air pressure monitoring system (TPMS: Tire Pressure Monitoring System) that detects the air pressure of tires provided in a vehicle and issues a warning or the like to a user if a detected air pressure is abnormal (e.g., JP 2005-193861A). The tire air pressure monitoring system includes a detection device that detects the air pressure of a tire and uses UHF band radio waves to wirelessly transmit an air pressure signal pertaining to the detected air pressure, and a monitoring device that receives the air pressure signal that was wirelessly transmitted by the detection device, and monitors the tire air pressure based on the received air pressure signal.

The monitoring device is provided on the vehicle body, and stores, in a memory, the sensor identifiers of respective detection devices in association with four tire positions at which tires are provided in the vehicle. Also, four LF transmission antennas, which are arranged in the vicinity of the respective tires, are connected to the monitoring device. The monitoring device uses LF (Low Frequency) band radio waves to transmit request signals including corresponding sensor identifiers to the respective tire positions from the LF transmission antennas that correspond to the tire positions. The communication range of each of the LF transmission antennas is basically limited to the range of the corresponding tire position, and therefore the monitoring device can transmit the request signals to the individual detection devices provided on the respective tires.

The detection devices are respectively provided on the front-right, front-left, rear-right, and rear-left tires, and if the sensor identifier included in a received request signal matches its own sensor identifier, a detection device wirelessly transmits an air pressure signal that includes an air pressure obtained by detection. The monitoring device receives air pressure signals transmitted from the detection devices, and monitors the air pressures of the tires.

In the tire air pressure monitoring system having this configuration, sensor identifiers are used to cause the detection devices to start up and transmit air pressure signals, and therefore even if another vehicle having a tire air pressure monitoring system approaches, it is possible to prevent the occurrence of crosstalk. Specifically, there are cases where a request signal transmitted from the monitoring device of one vehicle is received by not only a detection device provided on a tire of that vehicle, but also by a detection device provided on a tire of the other vehicle, but if the detection device receives a request signal that does not include its own sensor identifier, it does not transmit an air pressure signal, and crosstalk of air pressure signals does not occur.

Incidentally, in order to obtain a uniform wear state for four tires, tire rotation for interchanging the positions of the tires provided in the vehicle with each other is generally performed. If the position of a tire has changed, the monitoring device needs to update the correspondence relationship between the four tire positions and the identifiers. Basically, the monitoring device can use the LF transmission antennas at the tire positions to transmit request signals for requesting a sensor identifier, detect whether or not tire rotation was performed with use of the sensor identifiers that are transmitted from the detection devices in response to the request signals, and then update the correspondence relationship between the sensor identifiers and the four tire positions.

### SUMMARY

A tire air pressure monitoring system according to an aspect of the present disclosure includes a plurality of sensors that are respectively provided in a plurality of tires of a vehicle and detect air pressures of the tires; a memory that stores a plurality of tire positions at which the plurality of tires are respectively provided and identifiers of the sensors provided in the tires at the plurality of tire positions in correspondence with each other; and a controller that is configured to: perform wireless communication with the plurality of sensors with use of the identifiers of the sensors and monitors the air pressures of the tires, and transmit to at least one of the tire positions, at different timings, a first request signal that requests a piece of information and includes an identifier of the identifiers that is stored by the memory in correspondence with the at least one tire position, and a second request signal that requests a piece of information regardless of identifier content, wherein: the sensors are each configured to: receive the first request signal and the second request signal; transmit a response signal in a case where the identifier included in the first request signal received matches an identifier of the sensor; and in a case where the second request signal was received, transmits a response signal regardless of content of the identifier of the sensor, and the controller is further configured to: receive response signals that correspond to the first request signal and the second request signal; and determine whether or not both a single response signal was received in response to the first request signal and a single response signal was received in response to the second request signal.

A monitoring device according to an aspect of the present disclosure is a monitoring device that performs wireless communication with a plurality of sensors with use of identifiers of the sensors and monitors air pressures of a plurality of tires of a vehicle, the plurality of sensors being respectively provided in the tires and detecting air pressures of the tires, the monitoring device including a memory that stores a plurality of tire positions at which the plurality of tires are respectively provided and identifiers of the sensors provided in the tires at the plurality of tire positions in correspondence with each other; and a controller that is configured to: transmit to at least one of the tire positions, at different timings, a first request signal that requests a piece of information and includes an identifier of the identifiers that is stored by the memory in correspondence with the at least one tire position, and a second request signal that requests a piece of information regardless of identifier content; receive, in response to the first request signal, a response signal transmitted from the sensors that corresponds to the identifier included in the first request signal, and in response to the second request signal, receives a response signal transmitted from the sensors regardless of identifier content; and determine whether or not both a single response signal was received in response to the first request signal and a single response signal was received in response to the second request signal.

Note that the disclosure of the present application can not only be realized as a tire air pressure monitoring system and a monitoring device that include these characteristic processing units, but can also be realized as a tire air pressure monitoring method whose steps are these characteristic processes, or be realized as a program for causing a computer to execute these steps. Also, the disclosure can be realized as a semiconductor integrated circuit that realizes part of or the entirety of the tire air pressure monitoring system and the monitoring device, or be realized as another system that includes the tire air pressure monitoring system and the monitoring device.

### BRIEF DESCRIPTION OF THE DRAWINGS

FIG. 1 is a conceptual diagram showing an example of the configuration of a tire air pressure monitoring system according to an embodiment of the present disclosure.

FIG. 2 is a block diagram showing an example of the configuration of a monitoring device according to the embodiment of the present disclosure.

FIG. 3 is a conceptual diagram showing an example of an identifier table.

FIG. 4 is a block diagram showing an example of a configuration of a detection device.

FIG. 5 is a flowchart showing a processing procedure of the monitoring device pertaining to tire rotation detection processing.

### DETAILED DESCRIPTION OF EMBODIMENTS

### Problems Solved by Disclosure

In an environment in which there is little radio wave noise around a vehicle, and in which the detection devices are likely to receive request signals transmitted from the LF transmission antennas, there are cases where multiple detection devices react to a request signal transmitted from one LF transmission antenna, and transmit their sensor identifiers. In other words, there are cases where crosstalk occurs within the vehicle. In this case, there is a risk that even if tire rotation has actually been performed, the tire rotation is not detected, and the sensor identifiers are not updated. If the sensor identifiers are not updated, problems occur in tire air pressure monitoring.

An object of the present disclosure is to provide a tire air pressure monitoring system and a monitoring device that can detect that tire rotation was performed, with consideration given to the occurrence of crosstalk.

### Effects of Disclosure

According to the present disclosure, it is possible to provide a tire air pressure monitoring system and a monitoring device that can detect that tire rotation was performed, with consideration given to the occurrence of crosstalk.

### DESCRIPTION OF EMBODIMENTS OF DISCLOSURE

First, aspects for carrying out the present disclosure will be described. Also, at least portions of the embodiments described below may be combined as desired.

(1) A tire air pressure monitoring system according to an aspect of the present disclosure is a tire air pressure monitoring system including a plurality of detection devices that are respectively provided in a plurality of tires of a vehicle and detect air pressures of the tires, and a monitoring device that performs wireless communication with the plurality of detection devices with use of identifiers of the detection devices and monitors the air pressures of the tires, the monitoring device including: a storage unit that stores a plurality of tire positions at which the plurality of tires are respectively provided and identifiers of the detection devices provided in the tires at the plurality of tire positions in correspondence with each other; and a request signal transmission unit that transmits to at least one of the tire positions, at different timings, a first request signal that requests a piece of information and includes the identifier that is stored by the storage unit in correspondence with the at least one tire position, and a second request signal that requests a piece of information regardless of identifier content, the detection devices each including: a request signal reception unit that receives the first request signal and the second request signal; a first response signal transmission unit that transmits a response signal in a case where the identifier included in the first request signal received by the request signal reception unit matches the identifier of the detection device; and a second response signal transmission unit that, in a case where the second request signal was received by the request signal reception unit, transmits a response signal regardless of content of the identifier of the detection device, and the monitoring device further including: a response signal reception unit that receives response signals that correspond to the first request signal and the second request signal; and a determination unit that determines whether or not both a single response signal was received in response to the first request signal and a single response signal was received in response to the second request signal.

According to this aspect, a first request signal that includes an identifier corresponding to a tire position is transmitted to that tire position, and it is determined whether or not a single response signal was received in response to that first request signal, thus tentatively confirming that the tire was not replaced at that one tire position.

However, there are cases where crosstalk occurs, and the monitoring device receives a response signal that was transmitted from a detection device at another tire position. In view of this, the monitoring device transmits the second request signal to the one tire position. If any detection device receives the second request signal, it transmits a response signal regardless of the content of its own identifier. For this reason, by determining whether or not a single response signal was received in response to the second request signal, it is possible to check whether or not crosstalk is occurring. If crosstalk has occurred, the monitoring device will receive multiple response signals in response to the second request signal. If crosstalk is not occurring, the monitoring device will receive a single response signal.

Accordingly, by transmitting the first and second request signals, and then determining whether or not a single response signal was received in response to each of the request signals, it is possible to detect tire rotation with consideration given to crosstalk.

(2) In a preferable configuration, the determination unit includes a first determination unit that determines whether or not a single response signal was received in response to the first request signal, and a second determination unit that determines whether or not a single response signal was received in response to the second request signal, and before transmitting the second request signal, the request signal transmission unit transmits the first request signal, and in a case where the first determination unit determined that a single response signal was received, the request signal transmission unit then transmits the second request signal.

According to this aspect, the monitoring device is configured so as to first transmit the first request signal, and determine whether or not a single response signal was received in response to the first request signal.

When the monitoring device transmits the first request signal, there are cases where a single response signal is received, and cases where a response signal is not received. If a response signal is not received, it can be immediately determined that tire rotation, detection device replacement, or the like has been performed.

On the other hand, when the monitoring device transmits the second request signal, there are cases where a single response signal is received, and cases where multiple response signals are received. If multiple response signals are received, it can be immediately determined that a crosstalk problem is occurring, but in order to determine that detection device replacement was performed, it is necessary to transmit the first request signal.

Accordingly, in a normal state where crosstalk does not occur, by first determining the status of the response to the first request signal, the monitoring device can quickly detect that tire rotation, detection device replacement, or the like was performed.

(3) In a preferable configuration, the monitoring device individually transmits the first request signal and the second request signal to each of the plurality of tire positions at different timings, and the determination unit determines whether or not both a single response signal was received in response to the first request signal transmitted to each of the tire positions and a single response signal was received in response to the second request signal transmitted to each of the tire positions.

According to this aspect, the monitoring device can determine whether or not it is necessary to update the correspondence relationship between all of the tire positions and the identifiers stored in the storage unit, with consideration given to the occurrence of crosstalk.

(4) A monitoring device according to an aspect of the present disclosure is a monitoring device that performs wireless communication with a plurality of detection devices with use of identifiers of the detection devices and monitors air pressures of a plurality of tires of a vehicle, the plurality of detection devices being respectively provided in the tires and detecting air pressures of the tires, the monitoring device including: a storage unit that stores a plurality of tire positions at which the plurality of tires are respectively provided and identifiers of the detection devices provided in the tires at the plurality of tire positions in correspondence with each other; a request signal transmission unit that transmits to at least one of the tire positions, at different timings, a first request signal that requests a piece of information and includes the identifier that is stored by the storage unit in correspondence with the at least one tire position, and a second request signal that requests a piece of information regardless of identifier content; a response signal reception unit that receives, in response to the first request signal, a response signal transmitted from the detection device that corresponds to the identifier included in the first request signal, and in response to the second request signal, receives a response signal transmitted from the detection device regardless of identifier content; and a determination unit that determines whether or not both a single response signal was received in response to the first request signal and a single response signal was received in response to the second request signal.

According to this aspect, similarly to the first aspect, by transmitting the first and second request signals, and then determining whether or not a single response signal was received in response to each of the request signals, it is possible to detect tire rotation with consideration given to crosstalk.

### DETAILED DESCRIPTION OF EMBODIMENTS OF DISCLOSURE

Specific examples of a tire air pressure monitoring system according to an embodiment of the present disclosure will be described below with reference to the drawings.

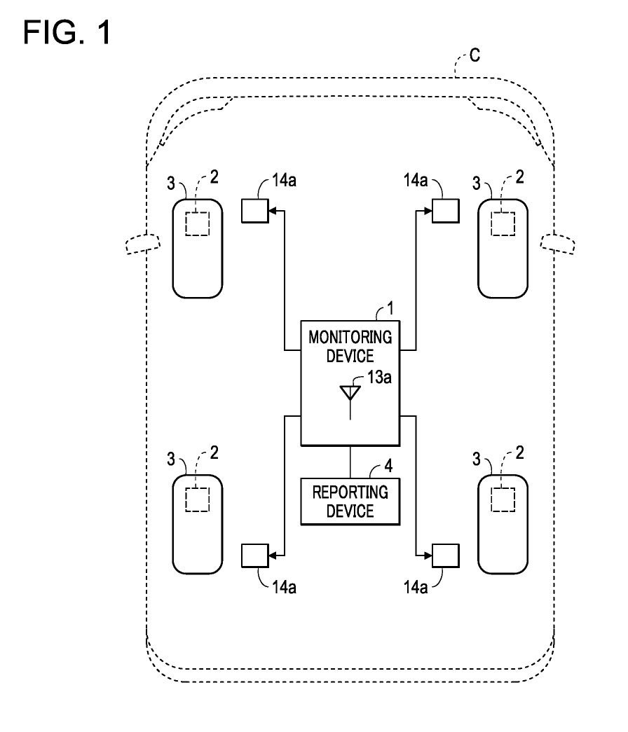

FIG. 1 is a conceptual diagram showing an example of the configuration of a tire air pressure monitoring system according to an embodiment of the present disclosure. The tire air pressure monitoring system according to the present embodiment includes a monitoring device 1 that is provided at an appropriate location on a vehicle body, multiple detection devices 2 that are respectively provided on the wheels of tires 3 provided in a vehicle C, and a reporting device 4. The detection devices 2 each detect the air pressure of the tire 3 on which it is provided. In the tire air pressure monitoring system of the present embodiment, the monitoring device 1 acquires information regarding the air pressures of the tires 3 by performing wireless communication with the detection devices 2, and uses the reporting device 4 to report the air pressures of the tires 3.

LF transmission antennas 14a that correspond to the tires 3 are connected to the monitoring device 1. For example, four LF transmission antennas 14a are respectively provided at the front-right, rear-right, rear-left, and the front-left tire positions of the vehicle C. The tire positions are the positions of tire houses or the vicinity thereof, and are positions at which the detection devices 2 provided on the tires 3 can individually receive signals transmitted from the respective LF transmission antennas 14a.

The monitoring device 1 uses LF (Low Frequency) band radio waves to transmit request signals requesting air pressure signals regarding the tires 3 from the LF transmission antennas 14a to the individual detection devices 2. The monitoring device 1 of the present embodiment has a function for transmitting a first request signal and a second request signal, which are different from each other, as signals for requesting air pressure signals.

The first request signal includes the sensor identifier of the detection device 2 provided on the tire 3 at the tire position that is the transmission destination. As will be described later, the monitoring device 1 stores the relationship between the tire positions at which the tires 3 are provided and the sensor identifiers of the detection devices 2 that are provided on the tires 3 at the respective tire positions. When a detection device 2 receives a first request signal that includes a sensor identifier that is the same as its own sensor identifier, that detection device 2 detects the air pressure of the tire 3, and uses UHF (Ultra High Frequency) band radio waves to transmit, to the monitoring device 1, a response signal that includes the air pressure obtained by detection and its own sensor identifier. The monitoring device 1 includes an RF reception antenna 13a, uses the RF reception antenna 13a to receive response signals transmitted by the detection devices 2, and acquires air pressure information regarding the tires 3 from the response signals.

The second request signal is a signal that does not include a specific sensor identifier, and unconditionally requests an air pressure signal. Although there are no particular limitations on the data structure of the second request signal, it has data similar to that of the first request signal, and includes a generic identifier instead of a sensor identifier, for example. When a detection device 2 receives the second request signal that has the generic identifier, that detection device 2 detects the air pressure of the tire 3 regardless of the content of its own sensor identifier, and uses UHF band radio waves to transmit, to the monitoring device 1, a response signal that includes the air pressure obtained by detection and its own sensor identifier.

Note that although the first request signal and the second request signal are described as signals for requesting an air pressure signal in the present embodiment, they may be simply signals for requesting the transmission of a response signal.

Note that the LF band and the UHF band are examples of the radio wave bands used when performing wireless communication, and the radio wave bands are not necessarily limited to these examples.

Furthermore, the reporting device 4 is connected to the monitoring device 1 via a communication line, and the monitoring device 1 transmits the acquired air pressures to the reporting device 4. The reporting device 4 receives the air pressure signals transmitted by the monitoring device 1, and reports the air pressures of the tires 3. Also, the monitoring device 1 emits a warning from the reporting device 4 if the air pressure of a tire 3 is below a predetermined threshold value.

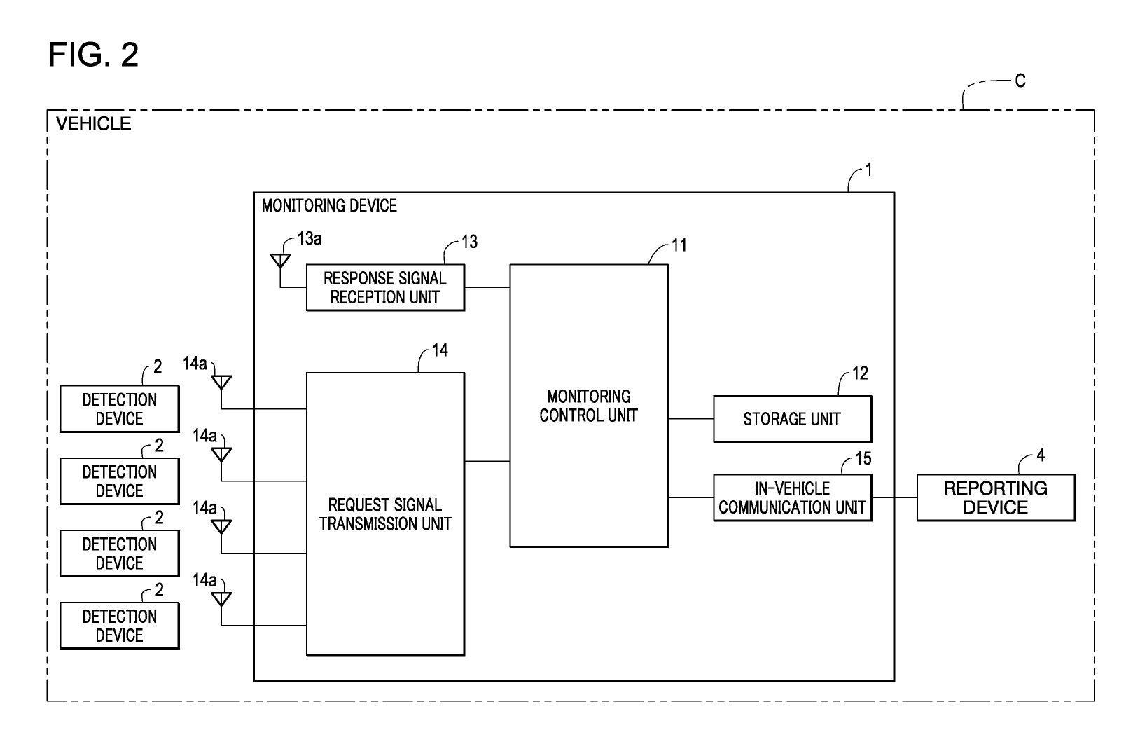

FIG. 2 is a block diagram showing an example of the configuration of the monitoring device 1 according to the embodiment of the present disclosure. The monitoring device 1 includes a monitoring control unit 11 that controls the operations of included constituent units. The monitoring control unit 11 is connected to a storage unit 12, a response signal reception unit 13, a request signal transmission unit 14, and an in-vehicle communication unit 15.

The monitoring control unit 11 is a microcontroller that has one or more CPUs (Central Processing Units) or a multi-core CPU, a ROM (Read Only Memory), a RAM (Random Access Memory), an input/output interface, and the like. The CPU of the monitoring control unit 11 is connected to the storage unit 12, the response signal reception unit 13, the request signal transmission unit 14, and the in-vehicle communication unit 15 via an input/output interface. By executing a control program stored in the storage unit 12, the monitoring control unit 11 controls the operations of the constituent units and executes tire air pressure monitoring processing according to the present embodiment.

The storage unit 12 is a non-volatile memory such as an EEPROM (Electrically Erasable Programmable ROM) or a flash memory. The storage unit 12 stores a control program for the execution of tire air pressure monitoring processing by the monitoring control unit 11 controlling the operations of the constituent units of the monitoring device 1. The storage unit 12 also stores an identifier table.

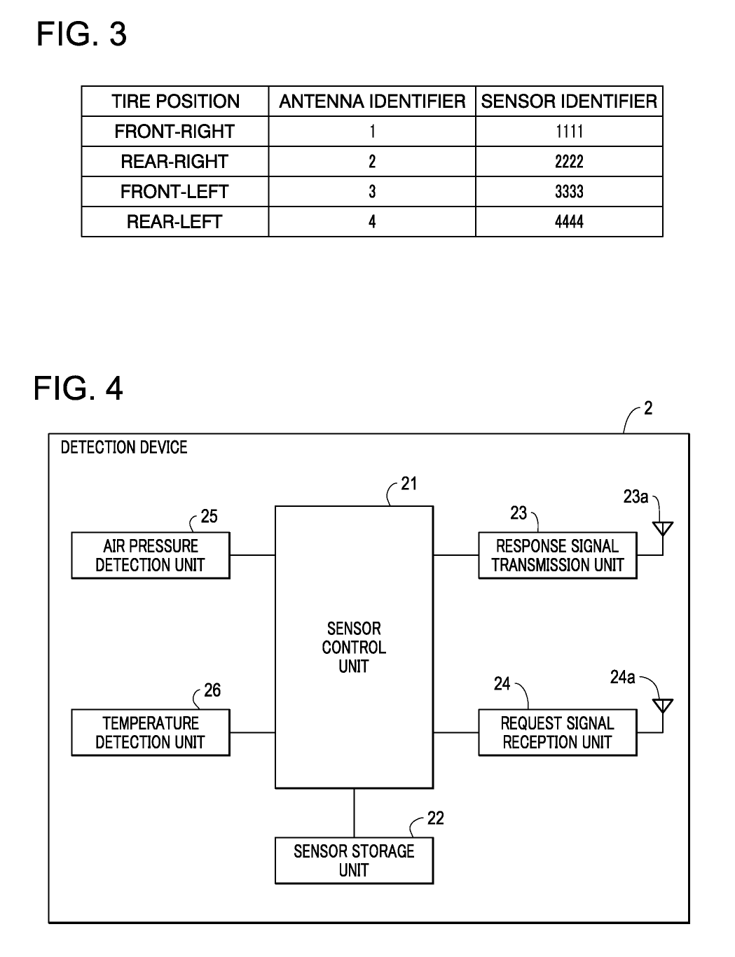

FIG. 3 is a conceptual diagram showing an example of the identifier table. The tire positions, antenna identifiers for identifying the LF transmission antennas 14a arranged in the vicinity of the tire positions, and the sensor identifiers of the detection devices 2 provided on the tires 3 at the tire positions are stored in the identifier table in correspondence with each other. Note that the antenna identifiers “1”, “2”, “3”, and “4” respectively indicate the LF transmission antennas 14a provided at the front-right, rear-right, front-left, and rear-left tire positions.

The RF reception antenna 13a is connected to the response signal reception unit 13. The response signal reception unit 13 uses the RF reception antenna 13a to receive signals that are transmitted by the detection devices 2 using RF band radio waves. The response signal reception unit 13 is a circuit that demodulates the received signals and outputs the demodulated signals to the monitoring control unit 11. The 300 MHz to 3 GHz UHF band is used as the carrier wave, but the present disclosure is not limited to this frequency band.

The request signal transmission unit 14 is a circuit that modulates signals output by the monitoring control unit 11 into LF band signals, and transmits the modulated signals from the LF transmission antennas 14a to the respective detection devices 2. Specifically, under control of the monitoring control unit 11, the request signal transmission unit 14 successively transmits the first request signal and the second request signal at different timings from the LF transmission antennas 14a. The 30 kHz to 300 kHz LF band is used as the carrier wave, but the present disclosure is not limited to this frequency band.

The in-vehicle communication unit 15 is a communication circuit that performs communication in accordance with a communication protocol such as CAN (Controller Area Network) or LIN (Local Interconnect Network), and is connected to the reporting device 4. The in-vehicle communication unit 15 transmits information regarding the air pressures of the tires 3 to the reporting device 4 under control of the monitoring control unit 11.

The reporting device 4 is, for example, a multi-information display or a head-up display that uses images to report information regarding the air pressures of the tires 3 that was transmitted by the in-vehicle communication unit 15. For example, the reporting device 4 displays air pressure information regarding the tires 3 mounted to the vehicle C. Also, the reporting device 4 may be, for example, a display unit or an audio device provided with a speaker that uses images or audio to report air pressure information. Examples of the display unit include a liquid crystal display, and an organic EL display.

FIG. 4 is a block diagram showing an example of the configuration of a detection device 2. The detection device 2 includes a sensor control unit 21 that controls the operations of constituent units of the detection device 2. The sensor control unit 21 is connected to a sensor storage unit 22, a response signal transmission unit 23, a request signal reception unit 24, an air pressure detection unit 25, and a temperature detection unit 26.

The sensor control unit 21 is a microcontroller that has one or more CPUs or a multi-core CPU, a ROM, a RAM, an input/output interface, and the like. The CPU of the sensor control unit 21 is connected to the sensor storage unit 22, the response signal transmission unit 23, the request signal reception unit 24, the air pressure detection unit 25, and the temperature detection unit 26 via an input/output interface. The sensor control unit 21 reads out a control program stored in the sensor storage unit 22, and controls various units. The detection device 2 includes a battery (not shown), and operates using power from this battery.

The sensor storage unit 22 is a non-volatile memory. The sensor storage unit 22 stores a control program for the CPU of the sensor control unit 21 to perform processing related to the detection and transmission of the air pressure of a tire 3. Note that the sensor storage unit 22 stores a unique sensor identifier for distinguishing that detection device 2 from another detection device 2.

An RF transmission antenna 23a is connected to the response signal transmission unit 23. The response signal transmission unit 23 modulates the response signal that was generated by the sensor control unit 21 to obtain a UHF band signal, and transmits the modulated response signal with use of the RF transmission antenna 23a.

An LF reception antenna 24a is connected to the request signal reception unit 24. The request signal reception unit 24 uses the LF reception antenna 24a to receive request signals that were transmitted from the monitoring device 1 using LF band radio waves, that is to say the first request signal and the second request signal, and outputs the received signals to the sensor control unit 21.

The air pressure detection unit 25 includes a diaphragm, for example, and detects the air pressure of the tire 3 based on a diaphragm deformation amount that varies according to the magnitude of pressure. The air pressure detection unit 25 outputs a signal indicating the detected air pressure of the tire 3 to the sensor control unit 21.

The temperature detection unit 26 includes elements whose electrical resistance changes according to the temperature for example, and detects the temperature of the tire 3 based on the voltage between the elements, which changes according to the change in temperature. The temperature detection unit 26 outputs a signal indicating the detected temperature of the tire 3 to the sensor control unit 21.

By executing a control program, the sensor control unit 21 of the detection device 2 having this configuration generates a response signal that corresponds to the content of the request signal, and transmits the response signal to the monitoring device 1 with use of the transmission unit 23. Specifically, upon receiving a first request signal that includes the same sensor identifier as its own, the sensor control unit 21 acquires the air pressure and the temperature of the tire 3 from the air pressure detection unit 25 and the temperature detection unit 26, generates a response signal that includes the air pressure, the temperature, the unique sensor identifier of the detection device 2, and the like, and outputs the response signal to the response signal transmission unit 23. Also, upon receiving the second request signal, the sensor control unit 21 acquires the air pressure and the temperature of the tire 3 from the air pressure detection unit 25 and the temperature detection unit 26, generates a response signal that includes the air pressure, the temperature, the unique sensor identifier of the detection device 2, and the like, and outputs the response signal to the response signal transmission unit 23.

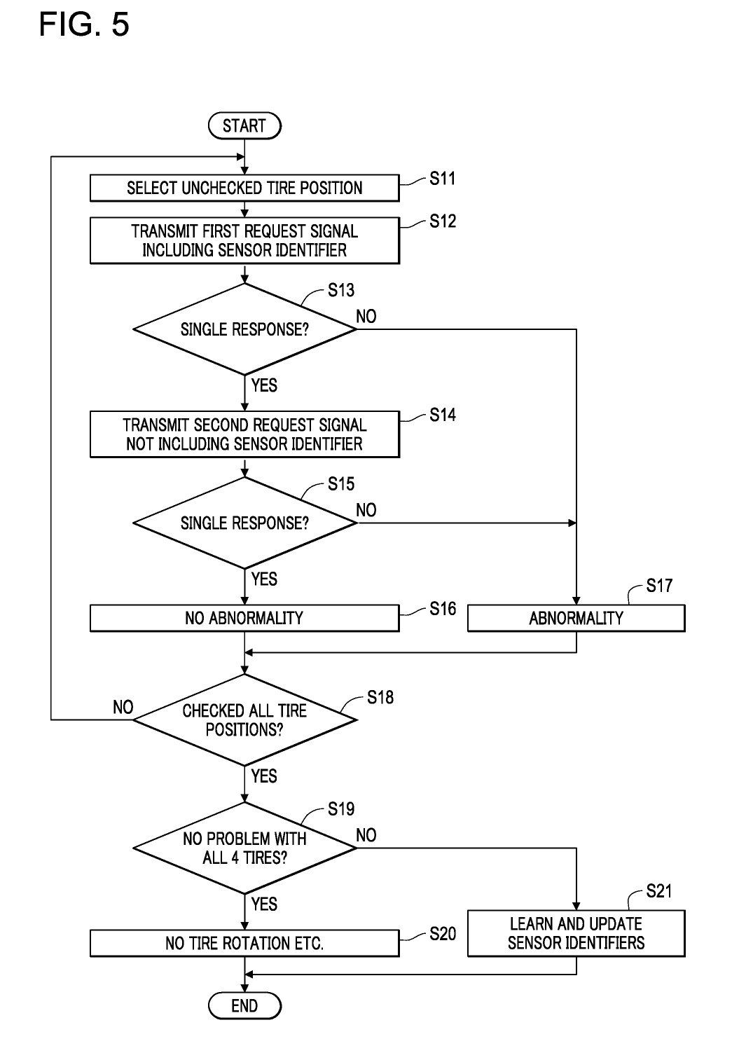

FIG. 5 is a flowchart showing a processing procedure of the monitoring device 1 pertaining to tire rotation detection processing. The following describes an example in which the monitoring device 1 detects that tire rotation was performed while acquiring air pressure information. Note that the monitoring device 1 may execute only processing pertaining to tire rotation detection, without requesting air pressure information. Also, although there are no particular limitations on the processing execution timing of the present embodiment, it may be executed when an ignition switch changes from the off state to the on state, for example.

For example, the monitoring control unit 11 executes the following processing when the ignition switch (not shown) has changed from the off state to the on state. First, out of the four “front-right”, “rear-right”, “front-left”, and “rear-left” tire positions, the monitoring control unit 11 selects one tire position for which the checking of the correspondence relationship with the sensor identifier has not ended (step S11). Hereinafter, the tire position selected in step S11 will be referred to as the one tire position. The monitoring control unit 11 then reads out, from the identifier table, the antenna identifier and the sensor identifier that correspond to the one tire position that was selected in step S11, and transmits a first request signal that includes the sensor identifier that corresponds to the one tire position from the LF transmission antenna 14a that corresponds to the antenna identifier that was read out (step S12).

Next, after transmission of the first request signal, the monitoring control unit 11 determines whether or not a single response signal was received in response to the first request signal by the response signal reception unit 13 within a predetermined timeout time (step S13). Upon determining that a single response signal was received in response to the first request signal (step S13: YES), the monitoring control unit 11 transmits a second request signal that does not include a specific sensor identifier from the LF transmission antenna 14a that corresponds to the antenna identifier that was read out in step S12 (step S14).

Next, after transmission of the second request signal, the monitoring control unit 11 determines whether or not a single response signal was received in response to the second request signal by the response signal reception unit 13 within a predetermined timeout time (step S15). Upon determining that a single response signal was received in response to the second request signal (step S15: YES), the monitoring control unit 11 stores an indication that there is no abnormality in the correspondence relationship between the sensor identifier and the one tire position that was selected in step S12 (step S16). In other words, it stores an indication that there is no abnormality such as that there was a change in the correspondence relationship between the sensor identifier and the one tire position due to tire rotation, tire replacement, or the like.

If it was determined in step S13 that a single response signal was not received in response to the first request signal (step S13: NO), or it was determined in step S15 that a single response signal was not received in response to the second request signal (step S15: NO), the monitoring control unit 11 stores an indication that there is an abnormality in the correspondence relationship between the sensor identifier and the one tire position that was selected in step S12 (step S17). In other words, there was a change in the correspondence relationship between the sensor identifier and the one tire position due to tire rotation, tire replacement, or the like, and it stores an indication that there is the problem that the correspondence relationship changed.

Note that regarding the situation in which a single response signal was not received in response to the first or second request signal, this situation includes the case where multiple response signals were received and the case where no response signal whatsoever was received. In the case where a response signal was not received in response to the request signal of the first request signal, and a single response signal was received in response to the second request signal, the monitoring device 1 can recognize that there is a possibility that tire replacement was performed.

After completing the processing of step S16 or step S17, the monitoring control unit 11 determines whether or not the processing for checking the correspondence relationship with the sensor identifier has ended for all of the tire positions (step S18). Upon determining that an unchecked tire position exists (step S18: NO), the monitoring control unit 11 returns the processing to step S11. Upon determining that the correspondence relationship with the sensor identifier has been checked for all of the tire positions (step S18: YES), the monitoring control unit 11 determines whether or not there was no problem in the correspondence relationship with the sensor identifier for all four of the tire positions (step S19). Upon determining that there was no problem in the correspondence relationship between all of the tire positions and the sensor identifiers (step S19: YES), the monitoring control unit 11 stores an indication that tire rotation or the like was not performed (step S20), and then ends this processing.

Upon determining that there was no problem in the correspondence relationship between all of the tire positions and the sensor identifiers, the monitoring control unit 11 uses the sensor identifiers stored in the identifier table to perform wireless communication with the detection devices 2 and monitor the air pressures of the tires 3. Specifically, the monitoring device 1 may monitor the air pressures of the tires 3 by transmitting air pressure request signals having corresponding sensor identifiers to the tire positions from the LF transmission antennas 14a identified by the corresponding antenna identifiers, and receiving air pressure signals transmitted by the detection devices 2 in accordance with the air pressure request signals. Also, in the case of a configuration in which air pressure signals are voluntarily transmitted from the detection devices 2, the monitoring device 1 may monitor the tire air pressures by specifying the air pressures at the respective tire positions by comparing the sensor identifiers included in the air pressure signals with the sensor identifiers stored in the identifier table.

Upon determining that there is a problem in the correspondence relationship between one of the tire positions and a sensor identifier (step S19: NO), the monitoring control unit 11 learns and updates the correspondence relationship between the tire positions and the sensor identifiers (step S21), and then ends this processing.

Although there are no particular limitations on the method of learning the correspondence relationship between the tire positions and the sensor identifiers in the processing of step S21, in one example, when the vehicle C starts to travel and the environment of the vehicle C changes, request signals requesting the sensor identifier are transmitted multiple times from the LF transmission antennas 14a, and the sensor identifiers included in the response signals corresponding to the request signals are aggregated. For example, a request signal is transmitted multiple times from the LF transmission antenna 14a at the front-right tire position, and multiple response signals are received. Then the sensor identifier with the highest frequency of appearance may be stored in the identifier table as the sensor identifier that corresponds to the front-right tire position. Similar processing is performed for the other tire positions as well, the correspondence relationship between all of the tire positions and the sensor identifiers is learned, and the identifier table is updated.

According to the tire air pressure monitoring system and the monitoring device 1 having such configurations, it is possible to detect that tire rotation was performed, with consideration given to crosstalk.

Also, the monitoring device 1 is configured so as to first transmit the first request signal, and determine whether or not a single response signal was received in response to the first request signal. Accordingly, in a normal state where crosstalk does not occur, by first determining the status of the response to the first request signal, the monitoring device 1 can quickly detect that tire rotation, replacement of a detection device 2, or the like was performed.

The embodiment disclosed here is to be considered in all respects as illustrative and not limiting.

1. A tire air pressure monitoring system comprising
a plurality of sensors that are respectively provided in a plurality of tires of a vehicle and detect air pressures of the tires;
a memory that stores a plurality of tire positions at which the plurality of tires are respectively provided and identifiers of the sensors provided in the tires at the plurality of tire positions in correspondence with each other; and
a controller that is configured to:
perform wireless communication with the plurality of sensors with use of the identifiers of the sensors and monitors the air pressures of the tires, and
transmit to at least one of the tire positions, at different timings, a first request signal that requests a piece of information and includes an identifier of the identifiers that is stored by the memory in correspondence with the at least one tire position, and a second request signal that requests a piece of information regardless of identifier content, wherein:
the sensors are each configured to:
receive the first request signal and the second request signal;
transmit a response signal in a case where the identifier included in the first request signal received matches an identifier of the sensor; and
in a case where the second request signal was received, transmits a response signal regardless of content of the identifier of the sensor; and
the controller is further configured to:
receive response signals that correspond to the first request signal and the second request signal; and
determine whether or not both a single response signal was received in response to the first request signal and a single response signal was received in response to the second request signal.

2. The tire air pressure monitoring system according to claim 1,
wherein the controller is further configured to:
determine whether or not a single response signal was received in response to the first request signal,
determine whether or not a single response signal was received in response to the second request signal, and
before transmitting the second request signal, transmit the first request signal, and in a case where the controller determines that a single response signal was received, transmit the second request signal.

3. The tire air pressure monitoring system according to claim 1,
wherein the controller is further configured to:
individually transmit the first request signal and the second request signal to each of the plurality of tire positions at different timings, and
determine whether or not both a single response signal was received in response to the first request signal transmitted to each of the tire positions and a single response signal was received in response to the second request signal transmitted to each of the tire positions.

4. A monitoring device that performs wireless communication with a plurality of sensors with use of identifiers of the sensors and monitors air pressures of a plurality of tires of a vehicle, the plurality of sensors being respectively provided in the tires and detecting air pressures of the tires, the monitoring device comprising:
a memory that stores a plurality of tire positions at which the plurality of tires are respectively provided and identifiers of the sensors provided in the tires at the plurality of tire positions in correspondence with each other; and
a controller that is configured to:
transmit to at least one of the tire positions, at different timings, a first request signal that requests a piece of information and includes an identifier of the identifiers that is stored by the memory in correspondence with the at least one tire position, and a second request signal that requests a piece of information regardless of identifier content;
receive, in response to the first request signal, a response signal transmitted from the sensors that corresponds to the identifier included in the first request signal, and in response to the second request signal, receives a response signal transmitted from the sensors regardless of identifier content; and
determine whether or not both a single response signal was received in response to the first request signal and a single response signal was received in response to the second request signal.
